(19) United States
(12) Patent Application Publication
(10) Pub. No.: US 2016/0213171 A1
(43) Pub. Date: Jul. 28, 2016

(54) DEVICE FOR PREVENTING SHOPLIFTING

(71) Applicant: SENECA SOLUTIONS, BESLOTEN VENNOOTSCHAP MET BEPERKTE AANSPRAKELIJKHEID, Antwerpen (BE)

(72) Inventor: Tom Jeff Sylvia SYMONS, Kapellen (BE)

(21) Appl. No.: 15/024,239

(22) PCT Filed: Sep. 23, 2014
(86) PCT No.: PCT/BE2014/000049

§ 371 Date: Mar. 23, 2016

(30) Foreign Application Priority Data
Sep. 23, 2013 (BE) 2013/0630

(51) Int. Cl. A47F 9/04; G07G 1/00

(52) U.S. Cl. CPC A47F 9/04; G07G 1/0036; A47F 2009/041

(57) ABSTRACT

Device for preventing shoplifting, characterised in that it automatically scans each shopping trolley (1) that is presented at a checkout (2) for payment of purchased goods via an optical and electronic system (3,6) for the presence of unpaid objects (9) in, under or behind the basket of the shopping trolley, while the shopping trolley (1) passes the checkout (2).

### FIELD OF THE INVENTION

The present invention relates to a device for preventing shoplifting.

More specifically the invention is intended for detecting unpaid goods in, behind or under shopping trolleys that are taken through a checkout of a shopping area or distribution centre to the outside.

### BACKGROUND OF THE INVENTION

It is known that unpaid goods are sometimes taken out of shopping areas because they are not detected at the checkout, and this can happen in good faith or with the intent to steal the goods.

Traditionally the staff at the checkout supervise the correct payment for the purchased goods, but nevertheless objects that are in, under or behind the shopping trolley or which are attached thereto escape notice because it is difficult for the staff to see them.

Traditionally some goods are carried under the basket or behind the basket of the shopping trolley and are therefore sometimes not noticed, because it is difficult for the staff to completely check all trolleys from their work position.

A disadvantage of this lack of detection is that the value of the goods thus lost remains unknown, as well as the type of goods and the times at which they are lost.

Another disadvantage of this lack of detection is that theft from the shopping area is inadequately discouraged, which leads to financial losses for the distribution centre.

### SUMMARY OF THE INVENTION

The purpose of the present invention is to provide a solution to the aforementioned and other disadvantages, by providing a device that enables inadvertent or deliberate shoplifting to be prevented.

To this end the invention concerns a device that automatically scans each shopping trolley presented at the checkout for payment of the purchased goods, by means of an optical and electronic system, for the presence of objects in, under or behind the basket of the shopping trolley while the shopping trolley passes the checkout.

Preferably the optical and electronic system consists of a camera connected to a computer, whereby the camera makes recordings whenever the presence of an object in, under or behind the basket of the shopping trolley is detected before, during or after the content of the shopping trolley is presented for payment.

Preferably the camera makes digital recordings that are sent to a central server, after which in a first phase the central server can identify the object or objects recorded by the camera by means of image recognition software, and in a second phase the central server can search for the identified object in the file of the goods for sale in the sales point and can thereby determine the sales value thereof.

Preferably the central server saves the detected objects, their sales value (phase 2), the time of detection and the location of their detection and generates a posteriori reports from this for analysis of the detected objects and the savings thereby realised.

Preferably the server is provided with a self-learning algorithm that improves the detection level of the device as the device stays in service for longer.

Preferably the camera is placed on a side of the passage for shopping trolleys at the checkout or at an extended position from the passage for shopping trolleys, whereby recordings are possible from above or in the sideways or oblique sideways direction from the shopping trolley, but also from the rear, front or top view of the shopping trolley.

The optical and electronic system sends a warning to the shop staff of the checkout by means of an audio or visual signal, such that they are alerted to objects still in or on the shopping trolley. In addition, in a later phase the optical and electronic system can be connected to the existing or installed software of the sales point and thus emit a detection signal.

The shop staff can thereupon take the necessary measures, such as collecting payment for unpaid goods or closing the exit until this payment has been settled.

An advantage of this device for preventing shoplifting is that a substantial saving can be realised with it, and shoplifting in a shopping trolley is discouraged.

Another advantage is that this device enables shoplifting to be prevented without having to burden the shop staff with additional surveillance tasks to this end.

An additional advantage is that by reporting all detections a picture is obtained of the type of goods and the times at which they are presented at the checkouts without being paid for, and also of the financial value that is recuperated by the system.

The device for preventing theft detects approximately 90% of the following larger objects that are outside the basket of the shopping trolley:
beer crates, cases of wine, champagne and spirits;
packs of water, lemonades and milk;
packs of detergents;
packs of diapers or toilet paper;
bags of the consumer that have to be checked.

95% of objects that are left behind in the basket of the shopping trolley are also detected, such as:
wine bottles and spirit bottles;
cartons of cigarettes;
crates of beer, water or sparkling drinks;
packs of detergents;
cases or boxes of bottles of wine, champagne or spirits.

### BRIEF DESCRIPTION OF THE DRAWINGS

With the intention of better showing the characteristics of the invention, a preferred embodiment of a device for preventing shoplifting according to the invention is described hereinafter by way of an example, without any limiting nature, with reference to the accompanying drawings, wherein:

FIG. 1 schematically shows a side view of a device for combating shoplifting according to the invention;

FIG. 2 shows the video recording camera of the optical system and the detected object of FIG. 1 in more detail;

FIG. 3 schematically shows the connection of the camera to a central server;

FIG. 4 shows an example of a report of detections drawn up by the central server.

### DETAILED DESCRIPTION OF A PREFERRED EMBODIMENT

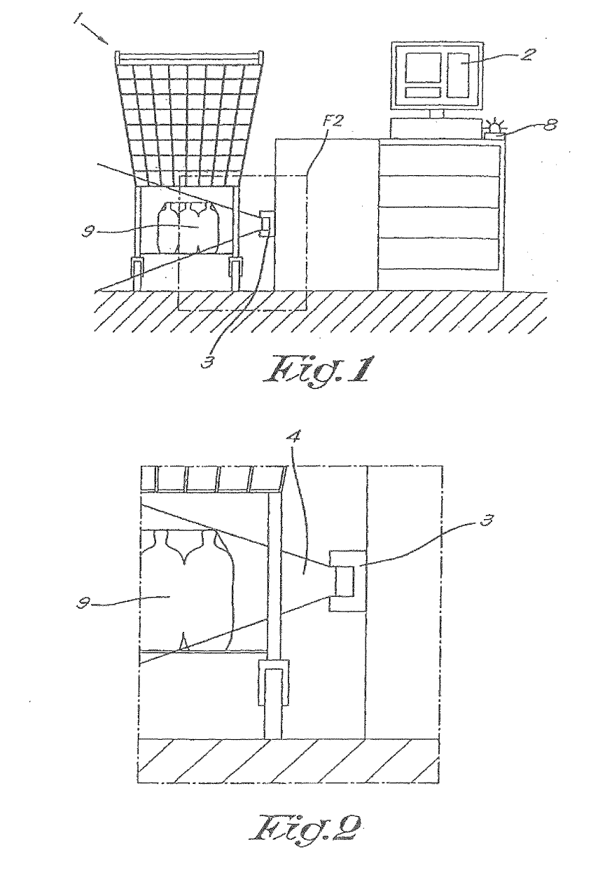

FIG. 1 shows a shopping trolley 1 that moves along a checkout 2 and of which a video recording is made by means of a camera 3, which in this case is on the side of the checkout 2.

FIG. 2 shows the digital camera 3 in more detail that makes the video recordings and which covers a specific field of view 4 from a certain angle to the shopping trolley 1 and also covers a part of the back of the shopping trolley 1.

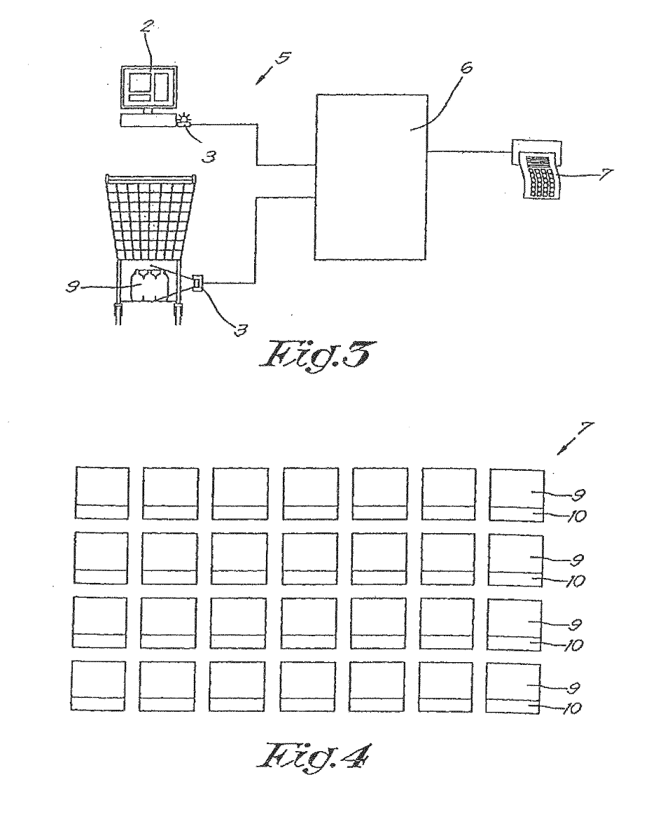

FIG. 3 shows the electronic diagram 5 by which the camera 3 is connected to a central server 6 that deals with the further analysis of the recordings and can provide reports 7 via a printer for example, or by e-mail in the form of a spreadsheet or another format. The server is also connected to a warning system 8 that alerts the checkout staff as soon as a suspect object is detected in the shopping trolley, or it can show a warning directly on the screen to the checkout staff or can pass on the warning to the checkout staff via the software of the point of sale.

FIG. 4 shows an example of a report 7 that is drawn up by the central server 6 in which the unpaid objects 9 are identified by means of their video recording, as well as their location and the time of presentation at the checkout 2, together with the sales value 10 of each detected object 9 insofar it is found in the file of goods for sale.

The operation of the device 1 is very simple and as follows.

A customer of a distribution centre presents himself at the checkout with his shopping trolley to pay for the purchased goods and places these goods on the conveyor belt provided at the checkout. The checkout staff read in the purchased goods by means of a barcode reader, for example, that identifies each presented object such that its sales value can be placed on the receipt.

If there are still objects in, on or behind the shopping trolley that have not been placed on the conveyor belt, the optical system according to the invention will detect the presence of them, make a video recording by means of a camera, which in this case is sidelong from the shopping trolley in the checkout and sends this recording to a central server.

The checkout staff are warned by means of an audio or visual signal or a picture on the screen or via the software of the point of sale, indicating that there are still objects in or on the shopping trolley, such that, if they are goods to be purchased, it can still add them to the receipt for the customer, so that its sales value is not lost for the shop manager.

The recordings that are sent by the camera to a central server are analysed by image recognition software so that the server can identify the detected goods and save the image, together with the sales value of the detected goods retrieved from the file of the goods for sale, and together with the location and the time of detection.

At a later time the central server can generate a report from the stored information that gives an overview of the detections that were made in a certain period, together with the location and sales values recovered by the device according to the invention.

Information can be drawn from this on the nature of the detected goods, where they are located, and at which checkouts or distribution centres they were detected, such that further more targeted measures to prevent shoplifting can also be taken.

It goes without saying that other detection techniques than the described detection techniques can be used for the same purpose and with the same intention.

For example it is also possible to send a real-time video recording in to the checkout staff so that the staff themselves can see and identify the goods that have not been read in.

The present invention is by no means limited to the embodiment described as an example and shown in the drawings, but a device for preventing shoplifting according to the invention can be realised in all kinds of forms and dimensions, without departing from the scope of the invention.

1-9. (canceled)

10. A device for preventing shoplifting of goods in a shopping trolley presented at the checkout of a shopping area, comprising:
an optical and electronic system with a camera provided at the checkout for automatically scanning each shopping trolley that is presented at the checkout for detecting the presence of unpaid objects, including bags of the consumer and such, in, under or behind the basket of the shopping trolley, while the shopping trolley passes the checkout,
a server connected to the optical and electronic system in such a way that digital recordings are made with the camera whenever the presence of an object in, under or behind the basket of the shopping trolley is detected, before, during or after the content of the shopping trolley has been presented for payment;
a warning system connected to the server to alert in real-time the checkout staff as soon as a suspect object is detected;
the server being provided with a self-learning algorithm that improves the detection level of the device as the device is in service for longer.

11. The device according to claim 10, wherein the server is provided with an image recognition software to identify the object or objects recorded by the camera.

12. The device according to claim 11, wherein the central server comprises a file of the goods for sale in the sales point in which the image recognition software can search for the identified object and can thereby determine its sales value.

13. The device according to claim 12, wherein the central server is arranged to save the detected objects, their sales value, the time of detection and the location of their detection and generates an a posteriori report from this for analysis of the detected objects and the savings attached thereto.

14. The device according to claim 10, wherein the camera is placed on a side of the passage for shopping trolleys at the checkout, or at an extended position from the passage for shopping trolleys, whereby recordings are possible from above or in the sideways or oblique sideways direction from the shopping trolley, but also of the rear view, front view or top view of the shopping trolley.

15. The device according to claim 10, wherein the warning system sends a warning to the checkout staff by means of an audio or visual signal or a picture on a screen, or can show a warning directly on screen or can pass it on to the checkout staff via the software of the point of sale such that they are alerted that objects are still in or on the shopping trolley.

16. The device according claim 10, wherein the warning system is arranged to sent a real-time video recording to the checkout staff so that the staff themselves can see and identify the goods that have not been read in.
